(19) United States
(12) Patent Application Publication
(10) Pub. No.: US 2014/0164369 A1
(43) Pub. Date: Jun. 12, 2014

(54) ITEM COUNT APPROXIMATION

(71) Applicant: Google Inc., Mountain View, CA (US)

(72) Inventors: Matthew J. Nichols, Woodinville, WA (US); Nikunj Bhagat, Tacoma, WA (US); Ian Porteous, Mercer Island, WA (US)

(73) Assignee: Google Inc, Mountain View, CA (US)

(21) Appl. No.: 13/796,369

(22) Filed: Mar. 12, 2013

Related U.S. Application Data
(60) Provisional application No. 61/735,195, filed on Dec. 10, 2012.

(51) Int. Cl. G06F 17/30

(52) U.S. Cl. CPC G06F 17/30536
USPC 707/725

(57) ABSTRACT

Methods, systems and apparatus, including computer programs encoded on computer storage media for approximating item counts. One of the methods includes maintaining a collection of counters for a class of items, processing each item in an item stream as a current item, including determining whether or not the collection includes an item counter for the current item, and if the collection includes an item counter for the current item, updating each count level in the item counter for the current item.

### CROSS REFERENCE TO RELATED APPLICATIONS

This application is a non-provisional of and claims priority to U.S. Provisional Patent Application No. 61/735,195, filed on Dec. 10, 2012, the entire contents of which are hereby incorporated by reference.

### BACKGROUND

This specification relates generally to approximating item counts over a fixed-size sliding time window.

Search systems index resources, e.g., social network updates, microblog posts, blog posts, news feeds, user generated multimedia content, images, videos, and web pages, and present information about the indexed resources to a user in response to receipt of a particular search query.

### SUMMARY

This specification describes techniques for determining approximate counts of frequently occurring items in a stream of items in a sliding time window, including approximate counts of frequently occurring kinds of the items that are being counted. Each occurrence of an item in a stream may be referred to as an “event.”

One example of an item is a search query that is defined by one or more attribute-value pairs. Examples of attributes of a search query include “user-entered text string,” “time of day,” “search query language,” “country of origin,” “state/country of origin,” or “city/state/country of origin.” Each item is further defined by an event time. For a search query item, the event time can be the time at which the query was received by a search system, for example, or the time the query was submitted by a user, or the time a user selected for viewing a resource from a search results page provided in response to the query, or the time at which a document that satisfies the query was indexed by the search system.

Search queries that are defined by one or more common attribute-value pairs can be counted as a single class of items. For example, search queries that are each defined by an attribute-value pair of (<user-entered text string>, “red cross”) can be counted as one class of items, which is defined by the value of the user-entered text string attribute. In another example, search queries that are each defined by the attribute-value pairs of (<user-entered text string>, “red cross”) and (<country of origin>, “US”) can be counted as one class of items, namely, search queries originating in the US that have the search string “red cross.” Alternatively, the class of items can be defined by the search string alone, and the country of origin can define an item kind, so that, for example, the items defined by the most frequently occurring search strings are counted, and for each of those items, the most frequently occurring countries of origin are counted.

In general, one innovative aspect of the subject matter described in this specification can be embodied in methods that include the actions of maintaining a collection of counters for a class of items, processing each item in an item stream as a current item, including determining whether or not the collection includes an item counter for the current item, and if the collection includes an item counter for the current item, updating each count level in the item counter for the current item. The collection includes a respective item counter for each distinct item in the class of items. Each item counter has one or more count levels. Each count level has a respective time-ordered list of one or more count blocks. Each count block has a respective offset and a respective timestamp. The method of processing each item in the item stream includes determining whether a timestamp of the current item is more recent than a timestamp of a most recent count block in the time-ordered list of the count level, (i) and if so, updating the count level by adding, to the time-ordered list of the count level, a count block having the timestamp of the current item, (ii) and otherwise, identifying, in the time-ordered list of the count level, a count block having a timestamp that is closest in time to the timestamp of the current item, and updating the respective count level by incrementing an offset of the identified count block. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination.

If the collection does not include an item counter for the current item and a number of item counters in the collection does not exceed a threshold, the method of processing each item as the current item can further include adding an item counter for the current item to the collection.

The method of processing each item can further include identifying each count block in the collection having a timestamp that is outside of a fixed-size sliding time window, and removing each identified count block from the collection.

After updating each count level in the item counter for the current item, the method can further include determining, for each count level in the collection, a respective collection count level block total, and updating each count level in each item counter in the collection. The method of updating each count level in each item counter can include removing a count block from a head of the ordered list for the count level being updated only if (i) the collection count level block total for the count level being updated exceeds a threshold and (ii) removal of the count block does not compromise an item-based error bound guarantee, adding a count block to the count level that is next highest relative to the count level from which the count block was removed, and associating the added count block with the timestamp of the removed count block.

If the collection includes a deleted block counter, the method of processing each item in the item stream can further include determining that the collection does not include an item counter for the current item, removing a respective count from each count level of each item counter in the collection, and incrementing a respective count of each count level of the deleted block counter.

The method can further include defining, for each count level in the item counter for the current item, a respective time range that is covered by the count level according to the timestamp of a count block at a head of the ordered list and the timestamp of a count block at a tail of the ordered list.

If the collection includes a deleted block counter, the method can further include generating an approximate count for a particular item in the class of items over a fixed-size sliding time window, including identifying, from among the count levels in the item counter for the particular item, the count level that encompasses the time window, and generating the approximate count for the particular item over the time window using data associated with the count blocks in the identified count level and data associated with the deleted block counter. If more than one count level covers the time window, the method of identifying the count level that encompasses the time window includes identifying the lowest count level that encompasses the time window.

Particular embodiments of the subject matter described in this specification can be implemented so as to realize one or more of the following advantages. The search system can identify frequently occurring items in a high-volume item stream and maintain item-based and class-based error bound guarantees for counts without requiring a large memory footprint. The search system can maintain counts over one or more respective time windows. The search system can maintain relative counts of different items or different pairs of items within a single class of items. The search system can compare counts from different time windows to determine if the frequency has changed with time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example search system.

FIG. 2 illustrates an example collection of counters that includes item counters.

FIG. 3 illustrates an example collection of counters that includes item counters and a deleted block counter.

FIG. 4 is a flow chart illustrating an example method for processing a current item in an item stream and updating a collection of counters that is associated with the current item.

FIG. 5 is a flow chart illustrating another example method for processing a current item in an item stream and updating a collection of counters that is associated with the current item.

Like reference numbers and designations in the various drawings indicate like elements.

### DETAILED DESCRIPTION

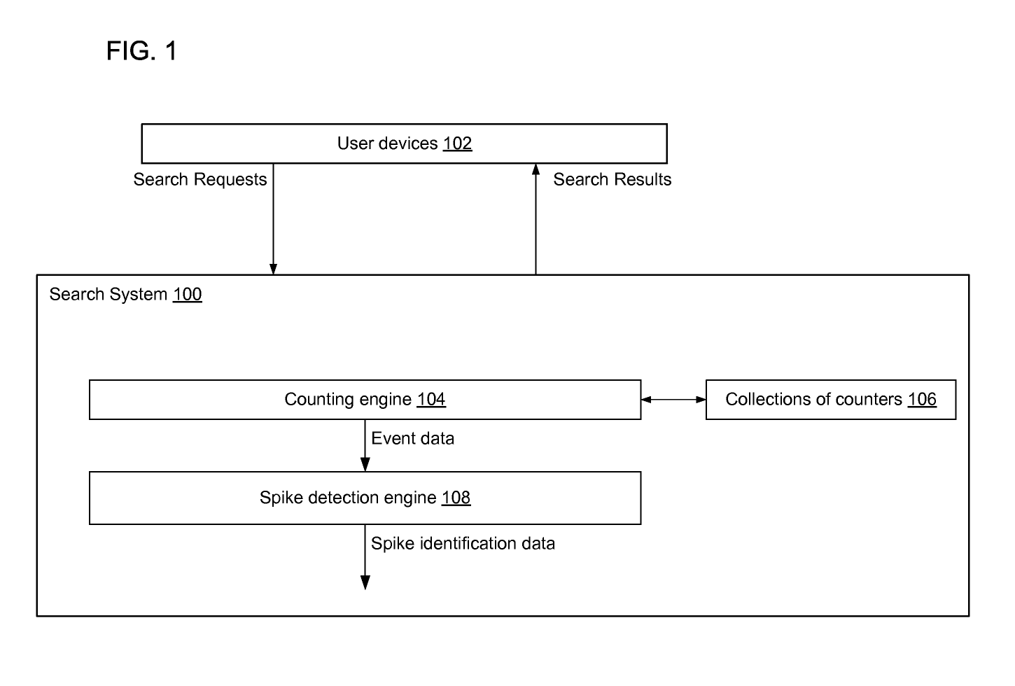

FIG. 1 is a block diagram of an example search system 100. The search system 100 receives search queries from user devices 102 through a network, for example, an intranet or the Internet, and provides search results that satisfy the search queries. The search system 100 includes a counting engine 104 that maintains collections of counters 106 for counting queries, and a spike detection engine 108. The search system 100 and the elements of the search system 100 can be implemented on one or more computers in one or more locations.

The search system 100 organizes the queries that it receives from the user devices 102 into an item stream and provides the item stream to the counting engine 104. The counting engine 104 finds frequent items in the item stream by tracking the most frequently occurring items in the item stream and monitoring counts associated with these items using the collections of counters 106. The counting engine 104 uses the collections of counters 106 to produce an approximate count of how many times a particular item occurred in a fixed-size sliding time window. The size of the time window can be a predetermined amount of time, e.g., fifteen, thirty, forty-five, sixty, ninety, one hundred and twenty or more minutes. In a fixed-size sliding time window, both ends of the window slide synchronously over the item stream.

In some implementations of the search system 100, as described below with reference to FIGS. 1, 2 and 4, the counting engine 104 generates an approximate count of a class of items, if the class is among the most frequently occurring classes, as will be described below. The approximate count of a class will be within an error bound guarantee. This type of error bound guarantee will be referred to as a “class-based error bound guarantee.” In some implementations of the search system 100, as described below with reference to FIGS. 1, 3 and 5, the counting engine 104 generates an approximate count of an item within both a class-based error bound guarantee, if the item is in a most frequently occurring class, and an error bound guarantee for the item itself. This latter type of error bound guarantee will be referred to as an “item-based error bound guarantee.” As noted above, frequency of occurrence is always determined with reference to a fixed-size sliding time window.

In addition to maintaining counts, the counting engine 104 generates event data representing rates of occurrence of classes of items and specific items over the fixed-size sliding time window. The spike detection engine 108 processes the event data using conventional techniques to generate spike identification data. The spike identification data identifies spikes, relative to historical baseline rates, which the spike detection engine 108 finds in the respective rates of occurrence of the frequently occurring classes and items. For example, the spike identification data can identify a spike in the rate of occurrence of items defined by the attribute-value pairs (<user-entered search query>, “red cross”) and (<country of origin>, “Germany”) at a time when no spike is detected in the rate of occurrence of items defined by the attribute-value pairs of (<user-entered search query>, “red cross”) and (<country of origin>, “Singapore”). With this information, a subsystem of the search system 100 that offers search suggestions can increase a likelihood that users operating client devices located in Germany who type in the word “red” will be offered a search suggestion of “red cross,” while the likelihood of such a suggestion for users operating client devices located in Singapore will not be changed.

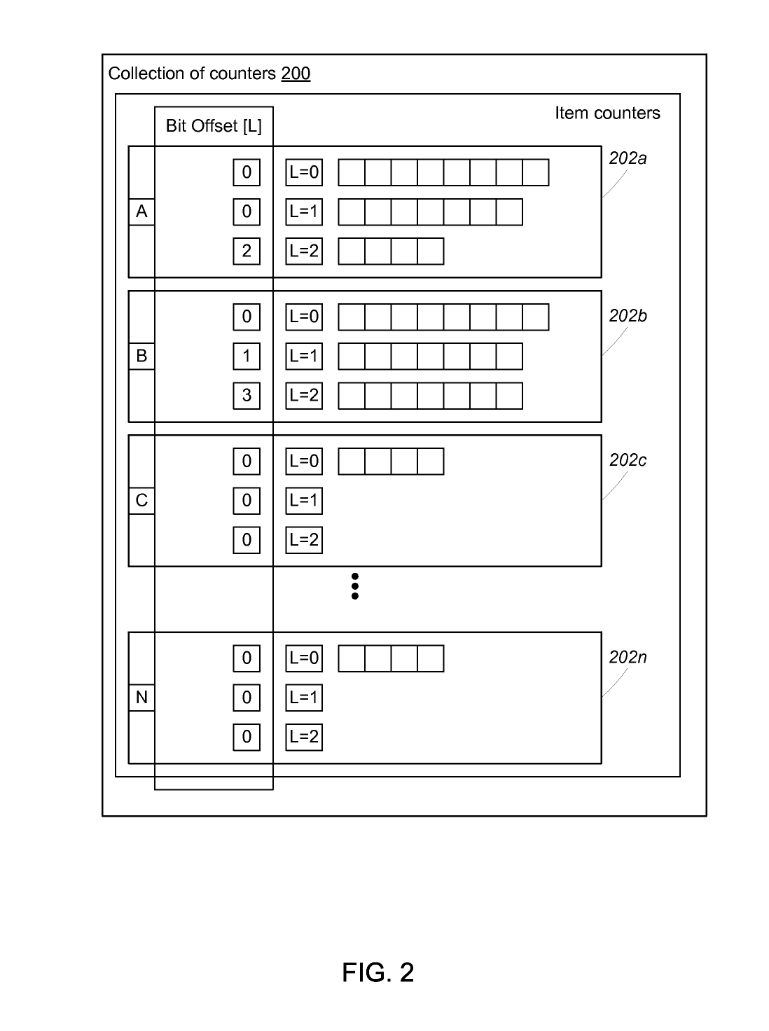

FIG. 2 illustrates an example collection of counters 200 that includes item counters 202a, 202b, 202c . . . 202n. The collection 200 is used to count a class of items; in the illustrated example, the class is queries having the search string “red cross.” These queries generally also have a country of origin attribute.

The counting engine 104 can be implemented to limit the number of item counters, n, that are included in the collection of counters 200, which will limit the amount of memory required by the item counters. For example, the number can be limited to 4/ε, where ε is a configuration parameter specifying a class-based error bound guarantee. In an implementation in which ε is 0.01, the number of item counters, n, will be limited to 400 counters.

Each item counter 202a, 202b, 202c . . . 202n maintains data from which a respective count can be approximated for items from each of n countries of origin. For example, item counter 202a maintains data from which a count can be approximated for items that are defined by the attribute-value pairs of (<user-entered search query>, “red cross”) and (<country of origin>, “France”), item counter 202b maintains data from which a count can be approximated for items that are defined by the attribute-value pairs of (<user-entered search query>, “red cross”) and (<country of origin>, “Germany”), and item counter 202c maintains data from which a count that can be approximated for items that are defined by the attribute-value pairs of (<user-entered search query>, “red cross”) and (<country of origin>, “Singapore”).

An item counter 202a, 202b, 202c . . . 202n can include one or more count levels. In the example shown in FIG. 2, each item counter 202a, 202b, 202c has exactly three count levels. The count levels are numbered sequentially, e.g., 0, 1, and 2, and are arranged hierarchically from lowest to highest. In an example item counter with count levels L=0, L=1, and L=2, the count level L=0 is the “lowest” count level while the count level L=2 is the “highest” count level, and count level L=1 is both higher than count level L=0 and lower than count level L=2.

Each count level has a respective time-ordered list of count blocks. The count block at the head of the time-ordered list will be referred to as the “head count block” and the count block at the tail of the time-ordered list will be referred to as the “tail count block.”

Each count block represents a count of 2^{L}. For example, each count block in count level L=0 represents a count of 1 (i.e., 2⁰=1), each count block in count level L=1 represents a count of 2 (i.e., 2¹=2), and each count block in count level 2 represents a count of 4 (i.e., 2²=4). Each count level is associated with a bit offset, Bit Offset [L]. In some implementations, the counting engine 104 generates the bit offset for each count level L as follows:
Bit Offset [L]=(Bit Count[L]+1)modulo 2^{L}

The Bit Count [L] is computed by multiplying the number of count blocks in the count level L by the number of items, 2^{L}, represented by each block. In the example item counter 202b illustrated in FIG. 2, the Bit Count [L] is 14 (7 count blocks in count level [L=1]×2¹) and the Bit Offset [L] is (14+1) modulo 2¹=1.

The counting engine 104 can be implemented to generate item counters 202a, 202b, 202c having an equal number of count levels, the exact number of which is based on the highest number of count levels that is needed to be maintained for any of the item counters in the collection, so that the class-based error bound guarantee is satisfied. In the example shown in FIG. 2, the item counter 202c has three count levels but does not include any count blocks in count levels L=1 and L=2.

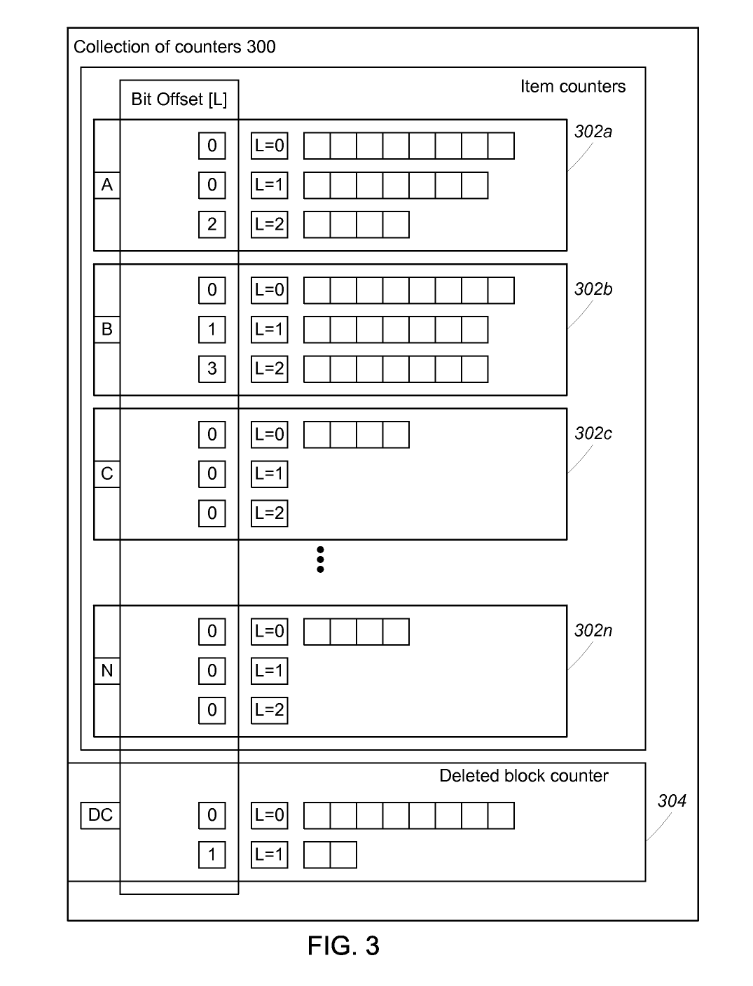

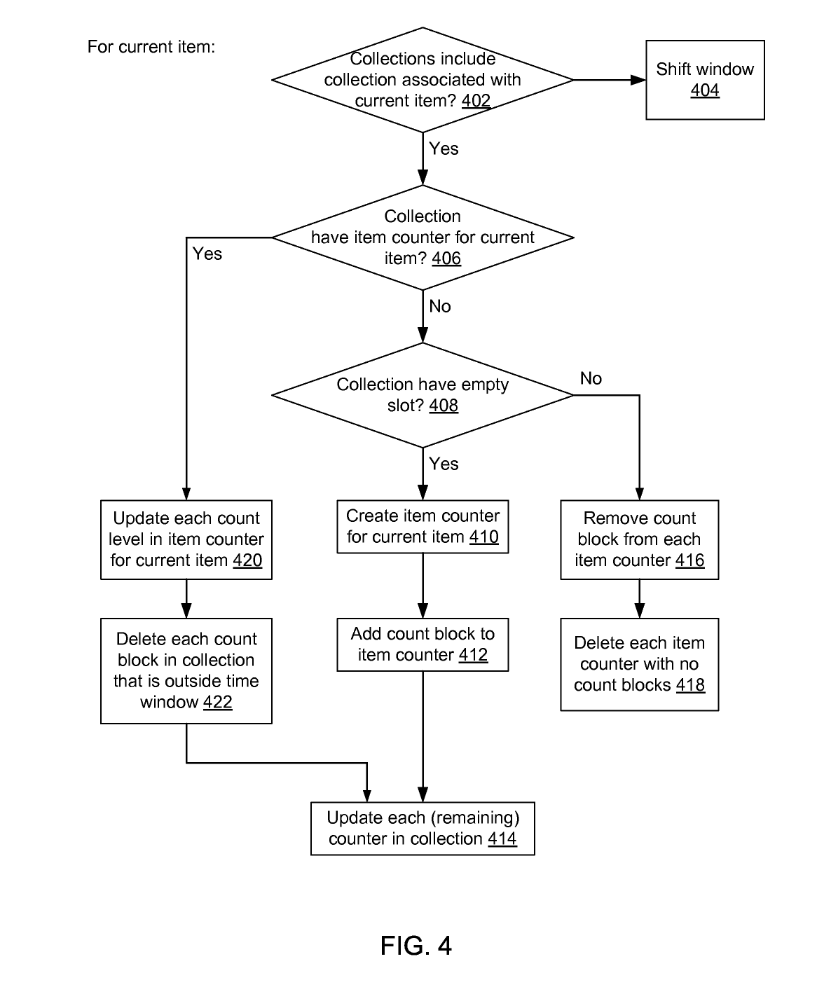

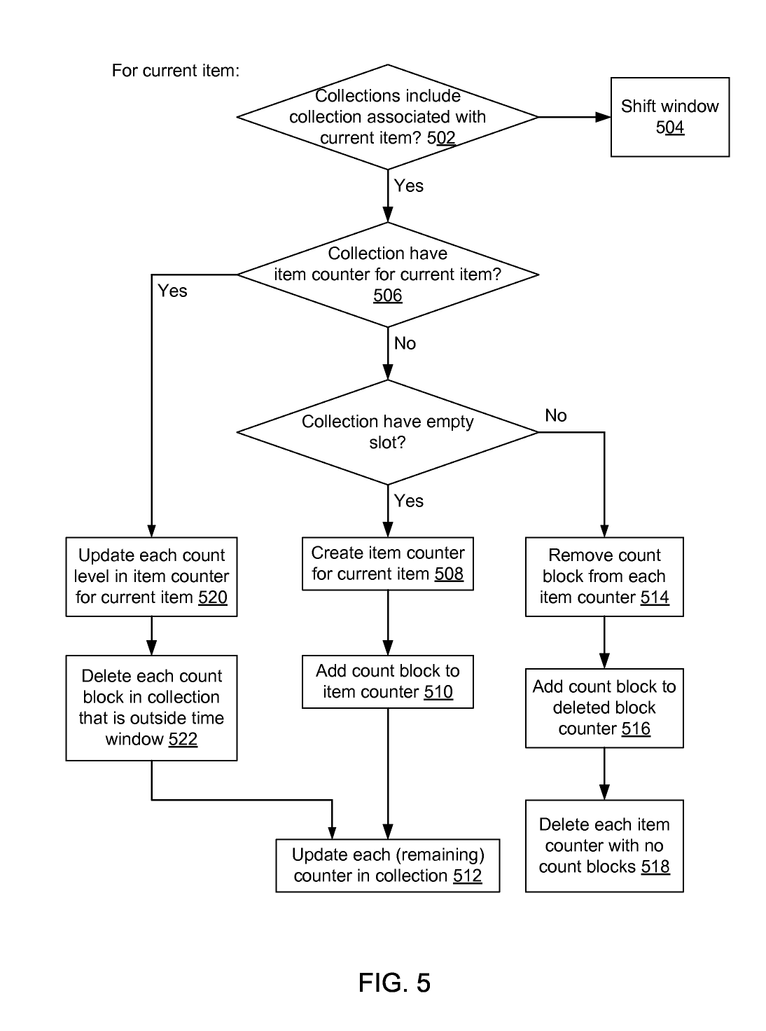

When a count block is added to a collection of counters, as described below with reference to FIGS. 4 and 5, the counting engine 104 associates a count index and a timestamp with the added count block. The count index is an ordinal number designating the place (e.g., first, second, or third) occupied by the added count block in an ordered sequence that encompasses all count blocks that have been added to the collection of counters by the counting engine since the collection of counters was first generated. The timestamp represents an event time of a particular item. In the implementation of the search system described below with reference to FIGS. 3 and 5, the counting engine 104 further associates an offset with the added count block. The offset represents a delta from the regular count represented by a block. For example, a count block in count level L=1 with an offset of 0 represents a count of 2 while a count block in the same count level with an offset of −1 represents a count of 1.

FIG. 3 illustrates an example collection of counters 300 that includes item counters 302a, 302b, 302c . . . 302n and a deleted block counter DC 304. The item counters 302a, 302b correspond to the item counters 202a, 202b (FIG. 2). Similar to the item counter 202c, the item counter 302c maintains data from which a count can be approximated for items that are defined by the attribute-value pairs of (<user-entered search query>, “red cross”) and (<country of origin>, “Singapore”). The difference between the item counter 202c and the item counter 302c is the number of count levels that are included in the item counter 302c. Initially, the item counter 302c includes one count level L=0. The item counter 302c will not include additional count levels until the counting engine 104 determines that removal of a count block from the count level L=0 will not result in a loss of information that could compromise the error bound guarantees for the item defined by the attribute-value pairs of (<user-entered search query>, “red cross”) and (<country of origin>, “Singapore”) in the fixed-size sliding time window.

Although the deleted block counter DC 304 is depicted as having two count levels, a deleted block counter can have zero or more count levels. As with the item counters, the count levels of the deleted block counter DC 304 are numbered sequentially beginning with zero and are arranged hierarchically from lowest to highest. Each count level of the deleted block counter 304 has a respective time-ordered list of one or more deleted blocks. Each deleted block represents a count of 2^{L}. When a new deleted block is added to the collection of counters, as described below with reference to FIG. 5, the counting engine 104 obtains the latest timestamp that is associated with the count blocks to be deleted and associates that timestamp with the new deleted block.

FIG. 4 is a flow chart illustrating an example method for processing a current item in an item stream and updating a collection of counters that is associated with the current item. For convenience, the method will be described in reference to a system that performs the method. The system can be, for example, the search system 100 described above with reference to FIG. 1, the item stream can be, for example, an item stream in which each item is defined by an attribute-value pair of (<user-entered text string>, <value>) and (<country of origin>, <value>), and the current item can be, for example, defined by the attribute-value pairs of (<user-entered text string>, “red cross”) and (<country of origin>, “Germany”).

The counting engine 104 determines whether or not the collections of counters 106 include a collection of counters that is associated with the current item (402). In some implementations, if the collections 106 do not include such a collection, the counting engine 104 shifts the fixed-size sliding time window to process the next item in the item stream (404). If, however, the collections 106 include a collection that is associated with the current item, the counting engine 104 determines whether or not the collection of counters 200 includes an item counter for the current item (406).

If the collection 200 does not include an item counter for the current item, the counting engine 104 first determines whether or not there is an empty slot in the collection 200 (408). In some implementations, the counting engine 104 makes this determination based on whether a limit on the number of item counters in the collection of counters 200 has been reached. If there remains a slot in the collection of counters 200 for another item counter, that is, the number of item counters is, for example, less than 4/ε, the counting engine 104 creates an item counter for the current item (410), adds a count block to count level L=0 of the newly-created item counter (412), and updates the other item counters in the collection 200 (414), as described below. If, however, the collection 200 does not have an empty slot, the counting engine 104 removes the oldest in time count block from each count level of each item counter (416). If, after such removal, an item counter does not have any remaining count blocks in any of its count levels, the counting engine 104 deletes the item counter (418), thereby opening up a slot in the collection of counters 200.

If the collection 200 includes an item counter for the current item, the counting engine 104 updates each count level in the item counter for the current item (420). In the example in which the current item is defined by the attribute-value pairs of (<user-entered search query>, “red cross”) and (<country of origin>, “Germany”), the counting engine 104 can update each count level in the item counter B 202b in FIG. 2 as follows:

For each count level L:
Bit Offset [L]=(Bit Count [L]+1) modulo 2^{L}
If Bit Offset [L]=0:
   Count Blocks [L]→Push Back Count

That is, if the computed Bit Offset [L] is zero, the counting engine 104 adds a count block to the tail of the time-ordered list of count blocks for the count level L.

The counting engine 104 identifies each count block in the collection of counters that has a timestamp that is outside of the fixed-size sliding time window and removes each identified count block from the collection (422).

Next, the counting engine 104 updates each item counter in the collection (414). In some implementations, the counting engine 104 performs this updating by first determining a total number of count blocks that each count level contains across all item counters in the collection. This total number of count blocks will be referred to as a “collection count level block total.” Referring to the example collection of counters 200 shown in FIG. 2, for example, the counting engine 104 determines a collection count level block total for count level L=0 by summing the number of count blocks in count level L=0 in item counters 202a, 202b, 202c . . . 202n. Next, the counting engine 104 determines, for each count level of each item counter in the collection, whether the removal of the head count block will compromise the class-based error bound guarantee. If such removal does not compromise the class-based error bound guarantee, the counting engine 104 removes the head count block. The counting engine 104 can do so by performing the following computation:

For each count level L:
While (count index of head count block×2^{L})<((approximate collection count/2^{L})+Bit Offset[L]+1−collection count level block total)
Remove head count block
If L=x, add a new count level L=x+1

The time range [begin_timestamp, end_timetamp] that is covered by each count level L is defined by the timestamps associated with the pair of count blocks at the head and the tail of the count level L.

Finally, after all of the item counters in the collection 200 are updated, the counting engine 104 can use the collection of counters 200 and the fixed-size sliding time window to produce approximate item counts and an approximate collection count for times greater than a time T, where T is within the fixed-size sliding time window. To do so, the counting engine 104 first identifies, for each item counter, the lowest count level that has a time range that encompasses the fixed-size sliding time window. For example, the counting engine 104 can identify the lowest count level with a begin_timestamp that is greater than time T. Next, the counting engine can perform the following computations to produce approximate item counts:

For each item counter:
L←lowest count level
Approximate item count=(2^{L}×(number of count blocks in L with timestamp>T))

The counting engine 104 then sums the approximate item counts to produce the approximate collection count and shifts the fixed-size sliding window to process the next item in the item stream as the current item.

FIG. 5 is a flow chart illustrating another example method for processing a current item in an item stream and updating a collection of counters that is associated with the current item. For convenience, the method will be described in reference to a system that performs the method. The system can be, for example, the search system 100 described above with reference to FIG. 1, the item stream can be, for example, an item stream in which each item is defined by an attribute-value pair of (<user-entered text string>, <value>) and (<country of origin>, <value>), and the current item can be, for example, defined by the attribute-value pairs of (<user-entered text string>, “red cross”) and (<country of origin>, “Germany”).

The counting engine 104 determines whether or not the collections of counters 106 include a collection of counters that is associated with the current item (502), and shifts the fixed-size sliding time window to process the next item in the item stream if the collections 106 do not include such a collection (504). If, however, the collections 106 include a collection that is associated with the current item, e.g., the collection 300, the counting engine 104 determines whether or not the collection of counters 300 includes an item counter for the current item (506).

If the collection 300 does not include an item counter for the current item and there is an empty slot in the collection of counters 300, the counting engine 104 creates an item counter for the current item (508), adds a count block to count level L=0 of the newly-created item counter (510), and updates the other item counters in the collection 300 (512), as described below. If, however, the collection 300 does not have an empty slot, the counting engine 104 removes a count from each count level of each item counter (514), and adds a count to each count level of the deleted block counter 304 (516). In step 512, if the Bit Offset [L] for a particular count level L is a non-zero value, the counting engine 104 decrements the Bit Offset [L] by 1. If, however, the Bit Offset [L] is 0, the counting engine 104 removes a count block from the count level L and sets the Bit Offset [L] to 2^{L}×1. If, after such removal, an item counter does not have any remaining count blocks in any of its count levels, the counting engine 104 deletes the item counter to open up a slot in the collection of counters 300 (518).

If the collection 300 includes an item counter for the current item, the counting engine 104 updates each count level in the item counter for the current item (520). In the example in which the current item is defined by the attribute-value pairs of (<user-entered search query>, “red cross”) and (<country of origin>, “Germany”), the counting engine 104 can update each count level in the item counter B 302b in FIG. 3 as follows:

For each count level L:
If (timestamp of current item>timestamp of tail count block):
   Bit Offset[L]=(Bit Count[L]+1) modulo 2^{L}
   If Bit Offset[L]=0:
      Count Blocks[L]→Push Back Count
Else (identify closest in time count block and increment value of offset of identified count block)

That is, if the timestamp of the current item is greater than the timestamp of the tail count block in the count level L, the counting engine 104 adds a count block to the tail of the time-ordered list of count block for the count level L. If, however, the timestamp of the current item is less than or equal to the timestamp of the tail count block in the count level L, the counting engine 104 identifies the count block in the count level L that has a timestamp that is closest in time to the timestamp of the current item and increments the offset of the identified count block by 1.

The counting engine 104 identifies each count block in the collection of counters that has a timestamp that is outside of the fixed-size sliding time window and removes each identified count block from the collection (522).

Next, the counting engine 104 updates each item counter in the collection 300 as a current item counter (512). In some implementations, the counting engine 104 performs this updating by first determining a collection count level block total for each count level of the collection, as described above with reference to FIG. 4. Next, the counting engine 104 determines a total number of count blocks that each count level of the current item counter contains. Each such total number will be referred to as an “item counter count level block total.” Referring to the example collection of counters 300 in FIG. 2, in an example in which the current item counter is the item counter 302b, the counting engine 104 determines an item counter count level block total for each count level L=0, L=1, and L=2 in the item counter 302b. Next, the counting engine 104 determines, for each count level of the current item counter, whether the removal of the head count block will compromise either the class-based error bound guarantee or the item-based error bound guarantee, ξ. If such removal does not compromise either, the counting engine 104 removes the head count block. The counting engine 104 can do so by performing the following computation:

For each count level L:
While (count index of head count block×2^{L})<((approximate collection count/2^{L})+Bit Offset[L]+1−collection count level block total) AND (item counter count level block total>4/ξ)
Remove head count block
If L=x, add a new count level L=x+1

The time range [begin_timestamp, end_timetamp] that is covered by each count level L is defined by the timestamps associated with the pair of count blocks at the head and the tail of the count level L.

Finally, after all of the item counters in the collection 300 are updated, the counting engine 104 can use the collection of counters 300 and the fixed-size sliding time window to produce approximate item counts and an approximate collection count for times greater than a time T, where T is within the fixed-size sliding time window. To do so, the counting engine 104 first identifies, for each item counter, the lowest count level that has a time range that encompasses the fixed-sized sliding time window. For example, the counting engine 104 can be implemented to identify the lowest count level with a begin_timestamp that is greater than time T. Next, the counting engine 104 can perform the following computations to produce approximate item counts:

For each item counter, including the deleted block counter:
L←lowest count level
Approximate item count=(2^{L}×(number of count blocks in L with timestamp>T))+sum(offsets of count blocks with timestamp>T+number of deleted block counter blocks in L with timestamp>T)

The counting engine 104 then sums the approximate item counts to produce the approximate collection count and shifts the fixed-size sliding time window to process the next item in the item stream.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

In some implementations, the search system batch processes the items in an item stream. In one example, the search system groups items having timestamps between T0 and T1 into a batch, sorts the items by user-entered search string, then sends the timestamps for each search string as a batch to the counting engine for processing. If, for example, T0 is less than (T1−window size), the search system can skip the processing of items having timestamps between T0 and (T1−window size). The search system can also delete the current item counters as every item in them will be deleted.

In the example methods described above with reference to FIGS. 4 and 5, it is assumed that the search system 100 will not create a collection of counters if the counting engine determines that the collection of counters do not include a collection that is associated with the current item. However, in some implementations of the search system, upon determining that the collections of counters do not include a collection that is associated with the current item, the counting engine generates such a collection.

In the examples described above, each count block represents a count of 2^{L}. In some implementations of the search system, each count block represents a count that is not a power of two. The error guarantees and storage requirements for such implementations are different than that described above with reference to FIGS. 1 through 5.

What is claimed is:

1. A computer-implemented method comprising:
maintaining a collection of counters for a class of items, wherein the collection includes a respective item counter for each distinct item in the class of items, wherein each item counter has one or more count levels, wherein each count level has a respective time-ordered list of one or more count blocks, and wherein each count block has a respective offset and a respective timestamp;
processing each item in an item stream as a current item, including:
determining whether or not the collection includes an item counter for the current item; and
if the collection includes an item counter for the current item, updating each count level in the item counter for the current item, including determining whether a timestamp of the current item is more recent than a timestamp of a most recent count block in the time-ordered list of the count level,
(i) and if so, updating the count level by adding, to the time-ordered list of the count level, a count block having the timestamp of the current item,
(ii) and otherwise, identifying, in the time-ordered list of the count level, a count block having a timestamp that is closest in time to the timestamp of the current item, and updating the respective count level by incrementing an offset of the identified count block.

2. The computer-implemented method of claim 1, wherein if the collection does not include an item counter for the current item and a number of item counters in the collection does not exceed a threshold, the method of processing each item as the current item further includes:
adding an item counter for the current item to the collection.

3. The computer-implemented method of claim 1, wherein processing each item further includes:
identifying each count block in the collection having a timestamp that is outside of a fixed-size sliding time window; and
removing each identified count block from the collection.

4. The computer-implemented method of claim 1, wherein after updating each count level in the item counter for the current item, the method further comprises:
determining, for each count level in the collection, a respective collection count level block total; and
updating each count level in each item counter in the collection, including:
removing a count block from a head of the ordered list for the count level being updated only if (i) the collection count level block total for the count level being updated exceeds a threshold and (ii) removal of the count block does not compromise an item-based error bound guarantee;
adding a count block to the count level that is next highest relative to the count level from which the count block was removed; and
associating the added count block with the timestamp of the removed count block.

5. The computer-implemented method of claim 1, wherein the collection further includes a deleted block counter, and wherein processing each item in the item stream further includes:
determining that the collection does not include an item counter for the current item;
removing a respective count from each count level of each item counter in the collection; and
incrementing a respective count of each count level of the deleted block counter.

6. The computer-implemented method of claim 1, further comprising:
defining, for each count level in the item counter for the current item, a respective time range that is covered by the count level according to the timestamp of a count block at a head of the ordered list and the timestamp of a count block at a tail of the ordered list.

7. The computer-implemented method of claim 1, wherein the collection further includes a deleted block counter, and wherein the method further comprises:
generating an approximate count for a particular item in the class of items over a fixed-size sliding time window, including:
identifying, from among the count levels in the item counter for the particular item, the count level that encompasses the time window; and
generating the approximate count for the particular item over the time window using data associated with the count blocks in the identified count level and data associated with the deleted block counter.

8. The computer-implemented method of claim 7, wherein, if more than one count level covers the time window, identifying the lowest count level that encompasses the time window.

9. A system comprising:
one or more computers and one or more storage devices storing instructions that are operable, when executed by the one or more computers, to cause the one or more computers to perform operations comprising:
maintaining a collection of counters for a class of items, wherein the collection includes a respective item counter for each distinct item in the class of items, wherein each item counter has one or more count levels, wherein each count level has a respective time-ordered list of one or more count blocks, and wherein each count block has a respective offset and a respective timestamp;
processing each item in an item stream as a current item, including:
determining whether or not the collection includes an item counter for the current item; and
if the collection includes an item counter for the current item, updating each count level in the item counter for the current item, including determining whether a timestamp of the current item is more recent than a timestamp of a most recent count block in the time-ordered list of the count level,
(i) and if so, updating the count level by adding, to the time-ordered list of the count level, a count block having the timestamp of the current item,
(ii) and otherwise, identifying, in the time-ordered list of the count level, a count block having a timestamp that is closest in time to the timestamp of the current item, and updating the respective count level by incrementing an offset of the identified count block.

10. The system of claim 9, wherein if the collection does not include an item counter for the current item and a number of item counters in the collection does not exceed a threshold, the operations of processing each item as the current item further include:
adding an item counter for the current item to the collection.

11. The system of claim 9, wherein the operations of processing each item further include:
identifying each count block in the collection having a timestamp that is outside of a fixed-size sliding time window; and
removing each identified count block from the collection.

12. The system of claim 9, wherein after updating each count level in the item counter for the current item, the operations further comprise:
determining, for each count level in the collection, a respective collection count level block total; and
updating each count level in each item counter in the collection, including:
removing a count block from a head of the ordered list for the count level being updated only if (i) the collection count level block total for the count level being updated exceeds a threshold and (ii) removal of the count block does not compromise an item-based error bound guarantee;
adding a count block to the count level that is next highest relative to the count level from which the count block was removed; and
associating the added count block with the timestamp of the removed count block.

13. The system of claim 9, wherein the collection further includes a deleted block counter, and wherein the operations of processing each item in the item stream further include:
determining that the collection does not include an item counter for the current item;
removing a respective count from each count level of each item counter in the collection; and
incrementing a respective count of each count level of the deleted block counter.

14. The system of claim 9, wherein the operations further comprise:
defining, for each count level in the item counter for the current item, a respective time range that is covered by the count level according to the timestamp of a count block at a head of the ordered list and the timestamp of a count block at a tail of the ordered list.

15. The system of claim 9, wherein the collection further includes a deleted block counter, and wherein the operations further comprise:
generating an approximate count for a particular item in the class of items over a fixed-size sliding time window, including:
identifying, from among the count levels in the item counter for the particular item, the count level that encompasses the time window; and
generating the approximate count for the particular item over the time window using data associated with the count blocks in the identified count level and data associated with the deleted block counter.

16. The system of claim 15, wherein, if more than one count level covers the time window, the operations of identifying the count level that encompasses the time window include identifying the lowest count level that encompasses the time window.

17. A computer program product, encoded on one or more non-transitory computer storage media, comprising instructions that when executed by one or more computers cause the one or more computers to perform operations comprising:
maintaining a collection of counters for a class of items, wherein the collection includes a respective item counter for each distinct item in the class of items, wherein each item counter has one or more count levels, wherein each count level has a respective time-ordered list of one or more count blocks, and wherein each count block has a respective offset and a respective timestamp;
processing each item in an item stream as a current item, including:
determining whether or not the collection includes an item counter for the current item; and
if the collection includes an item counter for the current item, updating each count level in the item counter for the current item, including determining whether a timestamp of the current item is more recent than a timestamp of a most recent count block in the time-ordered list of the count level,
(i) and if so, updating the count level by adding, to the time-ordered list of the count level, a count block having the timestamp of the current item,
(ii) and otherwise, identifying, in the time-ordered list of the count level, a count block having a timestamp that is closest in time to the timestamp of the current item, and updating the respective count level by incrementing an offset of the identified count block.

18. The product of claim 17, wherein if the collection does not include an item counter for the current item and a number of item counters in the collection does not exceed a threshold, the operations of processing each item as the current item further include:
adding an item counter for the current item to the collection.

19. The product of claim 17, wherein the operations of processing each item further include:
identifying each count block in the collection having a timestamp that is outside of a fixed-size sliding time window; and
removing each identified count block from the collection.

20. The product of claim 17, wherein after updating each count level in the item counter for the current item, the operations further comprise:
determining, for each count level in the collection, a respective collection count level block total; and
updating each count level in each item counter in the collection, including:
removing a count block from a head of the ordered list for the count level being updated only if (i) the collection count level block total for the count level being updated exceeds a threshold and (ii) removal of the count block does not compromise an item-based error bound guarantee;
adding a count block to the count level that is next highest relative to the count level from which the count block was removed; and
associating the added count block with the timestamp of the removed count block.

21. The product of claim 17, wherein the collection further includes a deleted block counter, and wherein the operation of processing each item in the item stream further include:
determining that the collection does not include an item counter for the current item;
removing a respective count from each count level of each item counter in the collection; and
incrementing a respective count of each count level of the deleted block counter.

22. The product of claim 17, wherein the operations further comprise:
defining, for each count level in the item counter for the current item, a respective time range that is covered by the count level according to the timestamp of a count block at a head of the ordered list and the timestamp of a count block at a tail of the ordered list.

23. The product of claim 17, wherein the collection further includes a deleted block counter, and wherein the operations further comprise:
generating an approximate count for a particular item in the class of items over a fixed-size sliding time window, including:
identifying, from among the count levels in the item counter for the particular item, the count level that encompasses the time window; and
generating the approximate count for the particular item over the time window using data associated with the count blocks in the identified count level and data associated with the deleted block counter.

24. The product of claim 23, wherein, if more than one count level covers the time window, the operations of identifying the count level that encompasses the time window include identifying the lowest count level that encompasses the time window.
